(19) United States
(12) Patent Application Publication
(10) Pub. No.: US 2016/0304761 A1
(43) Pub. Date: Oct. 20, 2016

(54) THERMOSTATIC MATERIALS, METHODS OF MAKING, AND USES THEREOF

(71) Applicant: EMPIRE TECHNOLOGY DEVELOPMENT LLC, Wilmington, DE (US)

(72) Inventor: Angele SJONG, Louisville, CO (US)

(73) Assignee: EMPIRE TECHNOLOGY DEVELOPMENT LLC, Wilmington, DE (US)

(21) Appl. No.: 15/102,172

(22) PCT Filed: Dec. 5, 2013
(86) PCT No.: PCT/US13/73236

§ 371 Date: Jun. 6, 2016

(51) Int. Cl. C09K 5/06; C08G 65/333; C08G 65/332

(52) U.S. Cl. CPC C09K 5/063; C08G 65/3322; C08G 65/33306

(57) ABSTRACT

Thermostatic materials and methods for making and using the materials are disclosed. The thermostatic materials have phase change materials (PCMs) incorporated into a composite with thermoreversible gels (TRGs) that undergo gelation prior to the melt temperature of the PCMs so that at temperatures at which the PCMs become liquid, the liquid PCM is retained by the gel, and at temperatures at which the gel becomes liquid, the liquid form of the gel is retained by a solid form of the PCM.

### BACKGROUND

Phase-change materials (PCMs) are materials with a high heat of fusion, or materials that are capable of storing and releasing large amounts of energy during a change in state of the material. For example, heat is absorbed or released by a PCM when the material changes from a solid to a liquid, and from a liquid to a solid. When the energy is stored or released as heat, the energy is referred to as latent heat, and the PCMs are classified as latent heat storage (LHS) units. Latent heat storage by PCMs may be achieved through various phase transitions such as solid-solid, solid-liquid, solid-gas and liquid-gas.

PCMs are therefore capable of providing passive thermal buffering properties due to the latent heat storage or release during reversible phase changes such as a reversible solid—liquid phase transition. Initially, for example, PCMs can behave like sensible heat storage materials and the temperature of the PCM rises as heat is absorbed. However, when the PCM reaches the temperature at which the phase change occurs (melting temperature), the PCM absorbs large amounts of heat while remaining at an almost constant temperature. The PCM continues to absorb heat without a significant rise in temperature until all of the PCM is transformed from the solid phase to the liquid phase. When the ambient temperature around a liquid PCM falls, the PCM solidifies, releasing the stored latent heat. Thus, at the melting/solidifying temperature, PCMs are able to provide thermal buffering.

A disadvantage of PCMs when used in thermal buffering of articles is the need to contain the liquid phase of the PCM upon melting in order to prevent loss of PCM and contamination of the article that is being thermally protected. Efforts to retain the liquid phase of the PCM within a confined area include containing the PCM in a nanostructure, such calcium silicate (NCS) platelet particles or aerogels, or covalently bonding the PCM to a rigid support system such as a cellulose fiber.

There remains a need for simple and cost effective modes of retaining the liquid phase of the PCM upon melting of the PCM.

### SUMMARY

Phase change materials (PCMs) may be incorporated into composite materials together with liquids that undergo gelation to form gels at a melt temperature of the PCM. Accordingly, at temperatures at which the PCM transitions from a solid phase to a liquid phase, the liquid phase of the PCM is retained by the gel, and at temperatures at which the gel transitions to a liquid, the liquid form of the gel is contained by the solid phase of the PCM.

In an embodiment, a thermostatic material includes at least one phase change material having a melt temperature, wherein at a temperature above the melt temperature the phase change material is a liquid phase change material, and at a temperature below the melt temperature the phase change material is a solid phase change material, and at least one thermoreversible gel having a gelation temperature, wherein at a temperature above the gelation temperature the thermoreversible gel is a gelled thermoreversible gel, and at a temperature below the gelation temperature the thermoreversible gel is a liquid thermoreversible gel, and wherein the gelation temperature is less than or equal to the melt temperature.

In an embodiment, a food packaging includes at least one phase change material having a solid state at a first temperature and a liquid state at a second higher temperature, and at least one thermoreversible gel having a liquid state at the first temperature and a gel state at the second temperature, wherein at least one of the at least one phase change material and the at least one thermoreversible gel is a solid or semi-solid at a temperature in a range of temperatures from a third temperature less than the first temperature to a fourth temperature greater than the second temperature.

In an embodiment, a method for thermally insulating a food item, includes providing a thermostatic material adjacent the food item, wherein the thermostatic material includes at least one phase change material having a melt temperature, wherein at a temperature above the melt temperature the phase change material is a liquid phase change material, and at a temperature below the melt temperature the phase change material is a solid phase change material, and at least one thermoreversible gel having a gelation temperature wherein at a temperature above the gelation temperature the thermoreversible gel is a gelled thermoreversible gel, and at a temperature below the gelation temperature the thermoreversible gel is a liquid thermoreversible gel, wherein the gelation temperature is less than or equal to the melt temperature.

In an embodiment, a method for producing a thermostatic material includes combining at least one phase change material with at least one thermoreversible gel, wherein the phase change material has a melt temperature at which the phase change material changes from a solid to a liquid, the thermoreversible gel has a gelation temperature at which the thermoreversible gel changes from a liquid to a gel, and the gelation temperature is less than or equal to the melt temperature.

### BRIEF DESCRIPTION OF THE FIGURES

FIG. 1 depicts a schematic representation of a thermostatic composite according to an embodiment.

FIG. 2 depicts a phase diagram of a PEG-PLGA-PEG copolymer according to an embodiment.

FIG. 3 depicts a representation of physical states of composite constituents with temperature changes according to an embodiment.

FIG. 4 depicts an illustrative heating/cooling diagram for a thermostatic composite according to an embodiment.

FIG. 5 depicts a poloxamer and method for conjugation of the poloxamer with a fatty acid to produce a thermostatic composite according to an embodiment.

### DETAILED DESCRIPTION

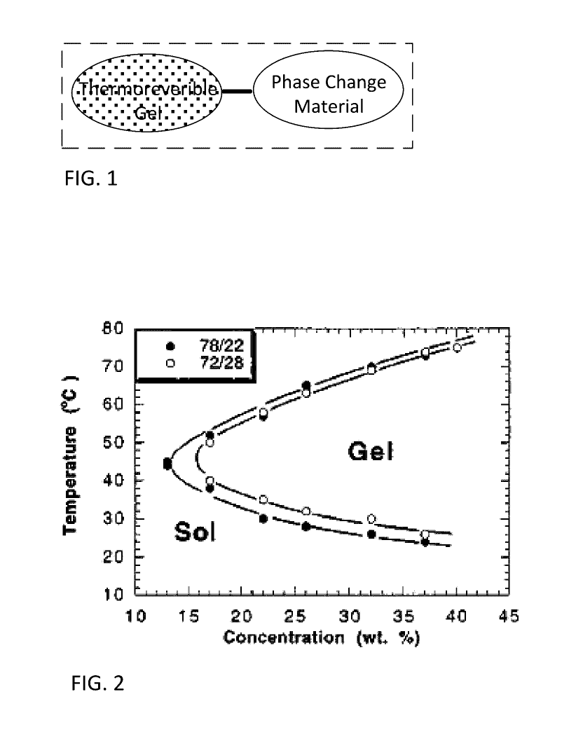

As represented schematically in FIG. 1, thermostatic composite materials that are capable of providing passive thermal buffering properties may include a phase change material (PCM) and a thermoreversible gel (TRG). Such thermostatic composites may be used for thermally insulating articles, such as food items, for example.

PCMs have a melt/solidification temperature at which the PCM changes between a solid and a liquid. Thus, a solid PCM will melt and become a liquid upon being heated to its melt temperature and a liquid PCM will solidify and become a solid upon cooling to below its melt temperature. Solid materials have a definite shape and structure and may be formed into shaped articles. As such, the PCM in its solid state may not require any additional containment during use. In liquid form however, the shape and structure are no longer definite and the PCM in its liquid state will disperse unless contained by a barrier material. Therefore, to use PCMs for thermal buffering, consideration must be given to containment of the PCMs upon melting.

In an embodiment, a TRG that is in a semi-solid (gel) state at the temperatures at which the PCM is undergoing melting, may be included with the PCM in a composite material such that the gel may retain the liquid form of the PCM. The TRG may be a gel that liquefies upon cooling and returns to its gel state when heated. Gels are semi-solid systems of small amounts of solids dispersed in liquid, but possessing solid-like character. Gel systems form a three-dimensional polymeric matrix in which long disordered chains are connected to one another at specific points, but the connections are reversible. TRGs are capable of gelling in response to an increase in temperature. FIG. 2 shows a representative phase-diagram for one exemplary type of TRG, showing that within a temperature range, the TRG may gel upon heating. Thermo-gelation mechanism may include partial crystallization, coil-to-helix transition, hydrophobic association and micelle packing, all of which serve to form reversible physical cross-linking points to from a gel.

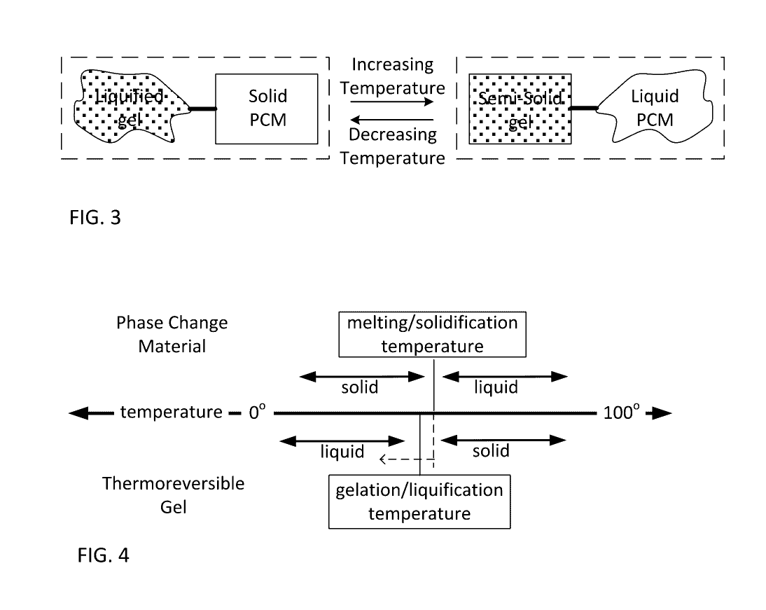

As shown in FIGS. 3 and 4, a thermostatic PCM-TRG composite may therefore be configured such that the composite may include a solid or semi-solid component that supports or retains any liquid components. As represented in FIG. 3, at lower temperatures, a solid PCM may support/retain a liquid TRG, and at higher temperatures, a gelled TRG may support/retain a liquid PCM.

The PCM-TRG composite may be configured as a thermostatic material. In one embodiment, the thermostatic material may include at least one PCM and at least one TRG. The PCM may have a melt temperature such that at a temperature above the melt temperature the PCM is a liquid PCM, and at a temperature below the melt temperature the PCM is a solid PCM. The TRG may have a gelation temperature such that at a temperature above the gelation temperature the TRG is a gelled TRG, and at a temperature below the gelation temperature the TRG is a liquid TRG. The gelation temperature can be less than or equal to the melt temperature. In some embodiments, at least one of the PCM and the TRG is a solid or semi-solid at a temperature less than the melt temperature, and at least one other of the PCM and the TRG is a solid or semi-solid at a temperature above the gelation temperature. In some embodiments, the PCM and the TRG are configured to maintain the thermostatic material in a flowable state over a range of temperatures from a first temperature less than the gelation temperature to a second temperature greater than the melt temperature. As represented in FIG. 4, a thermostatic composite may include a PCM and a TRG wherein the TRG is selected so that the gelation/liquification temperature of the TRG is less than or equal to the melt/solidification temperature of the PCM. Depending on the PCMs and the TRGs selected, the gelation temperature and the melt temperature may be about −10° C. to about 80° C., including about −10° C., about 0° C., about 10° C., about 20° C., about 30° C., about 40° C., about 50° C., about 60° C., about 70° C., about 80° C., or a temperature between any two of the indicated values.

In an embodiment, represented by the solid vertical lines in FIG. 4, the TRG may be a semi-solid or a gelled TRG at a temperature below the melt temperature of the PCM, such that, over a temperature range, the TRG may be in a semi-solid state and the PCM may be in a solid state. In an embodiment, the PCM may melt at the same temperature at which the TRG solidifies as represented by the dashed vertical line in FIG. 4. In some embodiments, the composite may be configured such that the TRG may be in the semi-solid state and the PCM may be in the solid state simultaneously for a temperature range that may be about 0° C. to about 10° C., or greater. In some embodiments, for example, the TRG may be in the semi-solid state and the PCM may be in the solid state simultaneously for a temperature range that may be about 0.5° C., about 1° C., about 1.5° C., about 2° C., about 2.5° C., about 31° C., about 3.5° C., about 4° C., about 4.5° C., about 5° C., about 5.5° C., about 6° C., about 6.5° C., about 7° C., about 7.5° C., about 8° C., about 8.5° C., about 9° C., about 9.5° C., about 10° C., or any range of temperatures between any of the indicated values, or greater than the indicated values.

In some embodiments, the PCM and the TRG may be configured such that the solid PCM retains the liquid TRG at temperatures less than or equal to the gelation temperature, and the gelled TRG retains the liquid PCM at temperatures greater than or equal to the melt temperature. In an embodiment as represented in FIG. 4 for a TRG-PCM composite, at a temperature above the melt/solidification temperature of the PCM, the PCM may be a liquid and the TRG may be a semi-solid or a gel. As the composite cools to a temperature below the melt temperature of the PCM, the PCM and the TRG may be a solids and a semi-solid respectively. As the composite cools further to a temperature below the gelation temperature of the TRG, the PCM may be a solid and the TRG may be a liquid. The reverse would then occur upon heating, with the composite changing from solid PCM/liquid TRG, to solid PCM/gelled TRG, to liquid PCM/gelled TRG.

The PCM-TRG composite may be configured as a thermostatic food packaging. In an embodiment, for example, a food packaging may include at least one PCM having a solid state at a first temperature and a liquid state at a second higher temperature, and at least one TRG having a liquid state at the first temperature and a gel state at the second temperature, wherein at least one of the at least one PCM and the at least one TRG is a solid or semi-solid at a temperature in a range of temperatures from a third temperature less than the first temperature to a fourth temperature greater than the second temperature.

The PCMs and TRGs may be selected such that, at least one of the PCMs and the TRGs is a solid or semi-solid at a temperature less than the melt temperature, at least one other of the PCMs and TRGs is a solid or semi-solid at a temperature above the gelation temperature. To enable any liquid materials to be retained within the composite, the PCM and TRG may be configured such that solid PCM retains liquid TRG at temperatures less than or equal to the gelation temperature, and gelled TRG retains liquid PCM at temperatures greater than or equal to the melt temperature.

Some examples of TRGs may include, but are not limited to, poly(ethylene glycol) (PEG), poly(ethylene glycol) grafted polymer such as poly(ethylene glycol) grafted chitosan, poly(ethylene glycol)-poly(lactic-co-glycolic acid)-poly(ethylene glycol) triblock copolymers (PEG-PLGA-PEG), and poloxamers (triblock copolymers of a central hydrophobic chain of poly(propylene glycol) flanked by two hydrophilic chains of poly(ethylene glycol)). In some embodiments, the TRGs may include a single type of TRG, or a combination of two or more different TRGs. In an embodiment, wherein the TRG may be a poly(ethylene glycol)-grafted polymer, the gelation temperature and liquid characteristics, as well as the ability of the TRG to have a thermoreversible sol-gel transition, may be altered by varying the amount of poly(ethylene glycol) that is grafted to the polymer. In an embodiment, a PEG-grafted chitosan may include poly(ethylene glycol) in an amount of about 45 wt % to about 55 wt %, including about 45 wt %, about 47 wt %, about 49 wt %, about 51 weight%, about 53 wt %, about 55 wt %, or an amount between any of the indicated values. In a composition that may be usable for the human body, a PEG-grafted chitosan may be configured to undergo a phase transition from an injectable free-flowing solution at a temperature below the body temperature to a gel at body temperature (about 37° C.). In an embodiment, the liquid state of a TRG, and may be a colloidal solution (for example, a sol) and the gelation temperature may be a sol-gel transition temperature.

Some examples of PCMs may include, but are not limited to, polycaprolactone, paraffin, paraffin constituents, functionalized paraffins, fatty acids, fatty acid esters, palmitates, stearates, vegetable oils, Micronal® (BASF Aktiengesellschaft, Ludwigshafen, Germany), or any combinations thereof. An example of a paraffin constituent may include eicosan. Examples of fatty acids may include, but are not limited to, capric acid, lauric acid, myristic acid, palmitic acid, stearic acid, and oleic acid. Examples of fatty acid esters may include, but are not limited to, palmitates, such as propyl palmitate and isopropyl palmitate, and stearates, such as isopropyl stearate and methyl-12 hydroxy-stearate. An example of a functionalized paraffin may include, but is not limited to, paraffin (CₙH₂ₙ₊₂) functionalized with maleic anhydride, where “n” is from about 16 to about 50. Some examples of paraffins and their melting temperatures are listed in Table 1. Some examples of fatty acids and their melting temperatures are listed in Table 2.

TABLE 1

| Compound | Melting temperature (° C.) | Heat of fusion (Kj/Kg) |
|---|---|---|
| Paraffin C16-28 | 42-44 | 189 |
| Paraffin C20-C33 | 48-50 | 189 |
| Paraffin C22-C45 | 58-60 | 189 |
| Paraffin wax | 64 | 173.6 |
| Paraffin C28-C50 | 66-68 | 189 |
| Paraffin RT40 | 43 | 181 |
| Paraffin RT50 | 54 | 195 |
| Paraffin RT65 | 64 | 207 |
| Paraffin RT80 | 79 | 209 |
| Paraffin RT90 | 90 | 197 |
| Paraffin RT110 | 112 | 213 |

TABLE 2

| Compound | Melting temperature(° C.) |
|---|---|
| Propyl palmitate | 10° |
| Isopropyl palmitate | 11° |
| Capric-lauric acids + pentadecane (90.10) | 13.3° |
| Isopropyl stearate | 14-18° |
| Caprylic acid | 16° |
| Capric-lauric acids (65 mol %-35 mol %) | 18.0° |
| Butyl stearate | 19° |
| Capric-lauric acids | 21° |
| (45-55%) | |
| Dimethyl sabacate | 21° |
| 34% Myristic acid + 66% Capric acid | 24° |
| Vinyl stearate | 27-29° |
| Capric acid | 32° |
| Methyl-12 | 42-43° |
| Hydroxyl-stearate | |
| Lauric acid | 42-44° |
| Myristic acid | 49-51° |
| Palmitic acid | 64° |
| Stearic acid | 69° |

In an embodiment, wherein the PCM is polycaprolactone, and the TRG is poly(ethylene glycol), the thermostatic material may be a polycaprolactone-poly(ethylene glycol)-polycaprolactone tri-block copolymer having a block ratio of polycaprolactone to poly(ethylene glycol) of about 0.5 to about 2, including about 0.5, about 0.7, about 0.9, about 1, about 1.2, about 1.4, about 1.6, about 1.8, about 2, or a value between any of the indicated values.

In some embodiments, a thermostatic material may include one or more different types of TRGs, in combination with any one or more different types of PCMs, to provide a composite material that has the ability to retain any liquid phase that may form over a selected temperature range. In an embodiment, a composite may have two different PCMs, each having a different melt/solidification temperature, and one TRG that is a gel at least when the PCM with the higher melt/solidification temperature is a liquid. In various alternative embodiments, a composite may have three PCMs and one TRG, or two PCMs and two TRGs, or one PCM and two TRGs, or any combination or number of PCMs and TRGs.

By selecting the composition of PCMs and TRGs in the composite, that is, varying the amounts of PCM and the TRG in the composite, and/or optionally any additives, for example, the characteristics of the composite may be varied. For example, a thermostatic material may be configured for keeping a food item at a temperature of about 5° C. during transport of the food article to protect the food item from spoilage. A PCM having a melt/solidification temperature of about 5° C. may be selected for the composite along with a TRG having a gelation temperature of about 3° C. In another example, a thermostatic material may be configured for keeping a beverage, such as coffee, at a temperature of about 65° C. for the convenience of the consumer during consumption of the beverage. A PCM having a melt/solidification temperature of about 65° C. may be selected for the composite along with a TRG having a gelation temperature of about 60° C.

In various other embodiments, the PCMs and the TRGs, and/or optionally other additives, may be selected so that a resulting thermostatic composite may be configured, for example, for maintaining hydration of articles while thermally buffering the articles, or alternatively, keeping an article dry. In some embodiments, a composite may be configured as any one or a combination of any of the following properties: flowable, anti-microbial, capable of maintaining hydration, capable of aeration, or capable of absorbing or releasing moisture (such as may be desired for produce packaging).

In an example, for fruit or vegetable storage, the composite may be configured such that at all temperatures, the composite is able to flow, thereby providing extra protection to the food items by penetrating small features on the surface of the food item and forming a skin and hydration buffer, while also hindering relative movement between the food items. In an embodiment, the composite may provide a form-fitting skin that is able to completely surround, protect and thermally buffer an article.

In an embodiment, the thermostatic material may be a coating applied to food, and the composite may include GRAS (generally regarded as safe) PCMs and TRGs that may be able to be washed away, or are edible materials themselves. In another embodiment, the thermostatic material may be configured as a packaging material for storing items, such as food items, therein.

In an embodiment, a thermostatic material may be produced by combining at least one PCM with at least one TRG, wherein the PCM has a melt temperature at which the PCM changes from a solid to a liquid, the TRG has a gelation temperature at which the TRG changes from a liquid to a gel, and the gelation temperature is less than or equal to the melt temperature.

In an embodiment, the thermostatic material may be produced by covalently bonding a PCM with a TRG. Accordingly, in one embodiment, the PCM may be liquefied and covalently bonded with the TRG.

To covalently bond the PCM to the TRG, each of the PCM and the TRG may have a reactive functional group that is capable of being reacted with the functional group of the other of the PCM and TRG. For example, the PCMs or TRGs may have a reactive carbonyl group that is able to react with an amine group of the TRGs or PCMs to form an imine bond, or the PCMs or TRGs may have a reactive carboxylic acid group that is able to react with an amine group of the TRGs or PCMs to form an amide bond. In an embodiment, a TRG and a PCM may be bonded via an alkyne-azide cycloaddition (click chemistry), wherein the PCM or TRG may include, or be modified to include, an azide group, and the other of the TRG or PCM may include, or be modified to include an alkyne group. In various other embodiments, a TRG and a PCM may be coupled via a thiol-Michael addition click reaction, or via a hexamethylene diisocyanate. In one additional embodiment, for example, thermoreversible gelation of biodegradable poly(caprolactone) and poly(ethylene glycol) multiblock copolymers in aqueous solutions may be used for coupling of the PCM with the TRG.

If a PCM or TRG does not have any available or appropriate reactive functional groups, the PCM or TRG may be functionalized by, for example, first reacting the PCM or TRG in a manner to introduce such a group onto the PCM or TRG. As an example, wherein the PCM may be a fatty acid having a carboxyl group, a TRG may be functionalized with an amino group. For example, a TRG may be amino terminated to provide a free amino group on the TRG to react with the carboxyl group of the fatty acid. The amino groups of the TRG and the carboxyl groups of the fatty acid may be conjugated to form a TRG-fatty acid copolymer.

In an embodiment, where the PCM is stearic acid and the TRG is a poloxamer, the thermostatic material may be a poloxamer-stearate copolymer. Accordingly, the poloxamer may be amino terminating to provide free amino groups on the poloxamer, and the combining step may include liquefying the stearic acid, and conjugating the amino groups of the poloxamer and the carboxyl groups of the stearic acid to form the poloxamer-stearate copolymer.

In further embodiments, the TRG may be porous, and the PCM may be liquefied and infiltrated into pores of the TRG. Accordingly, in an embodiment wherein the TRG is porous, the combining step may include liquefying the PCM, and infiltrating the PCM into pores of the thermoreversible gel.

Functional constituents may also be grafted onto a PCM or TRG. For example, maleic anhydride may be grafted onto paraffin PCM to produce a PCM material having a reactivity for an amide, such as an amide on a TRG. Paraffin may be mechanically mixed with maleic anhydride and dibenzoyl peroxide, and then heated to above the melt temperature of the paraffin in an inert atmosphere (for example, to about 140° C. in a nitrogen atmosphere) to melt the paraffin. The resultant liquid may be cooled until it solidifies, and the solid material may be ground and washed with cool water to remove any unreacted maleic anhydride. The resultant product may be dried to provide reactive PCM paraffin. The drying may be performed at temperatures above ambient temperature, for example, around 50° C. in an oven.

A food item may be thermally insulated by providing a thermostatic material adjacent to the food item, wherein the thermostatic material includes at least one PCM and at least one TRG. The PCM has a melt temperature, and at a temperature above the melt temperature the PCM is a liquid PCM, and at a temperature below the melt temperature the PCM is a solid PCM, and the TRG has a gelation temperature wherein at a temperature above the gelation temperature the TRG is a gelled TRG, and at a temperature below the gelation temperature the TRG is a liquid TRG, and the gelation temperature is less than or equal to the melt temperature.

In an embodiment, the thermostatic material may be in a flowable state, and the thermostatic material may be applied over the food item, so that the thermostatic material flows over the food item to conform to a contour of the food item.

In an embodiment, the food item may be coated with a layer of the thermostatic material. The TRG may include poly(ethylene glycol), poly(ethylene glycol) grafted chitosan, a poloxamer, poly(ethylene glycol)-poly(lactic-co-glycolic acid)-poly(ethylene glycol) triblock copolymer, or combinations thereof. The PCM may include polycaprolactone, paraffin, paraffin constituents, fatty acids, fatty acid esters, palmitates, stearates, vegetable oils, Micronal®, or combinations thereof

In an embodiment, a food item may be thermally insulated by providing, adjacent the food item, a TRG-PCM thermostatic material wherein the PCM is polycaprolactone, the TRG is poly(ethylene glycol) and the thermostatic material is one of a polycaprolactone-poly(ethylene glycol)-polycaprolactone tri-block copolymer and a poly(ethylene glycol)-polycaprolactone block copolymer.

In an embodiment, a food item may be thermally insulated by providing, adjacent the food item, a TRG-PCM thermostatic material wherein the PCM is polycaprolactone, the TRG is poly(ethylene glycol) and the thermostatic material is a polycaprolactone-poly(ethylene glycol)-polycaprolactone tri-block copolymer comprising a block ratio of polycaprolactone to poly(ethylene glycol) of about 0.5 to about 2.

In an embodiment, a food item may be thermally insulated by providing, adjacent the food item, a TRG-PCM thermostatic material wherein the PCM is stearic acid, the TRG is a poloxamer and the thermostatic material is a poloxamer-stearate copolymer.

### EXAMPLES

### Example 1

### A Poloxamer-Fatty Acid Thermostatic Composite for Maintaining Cooling

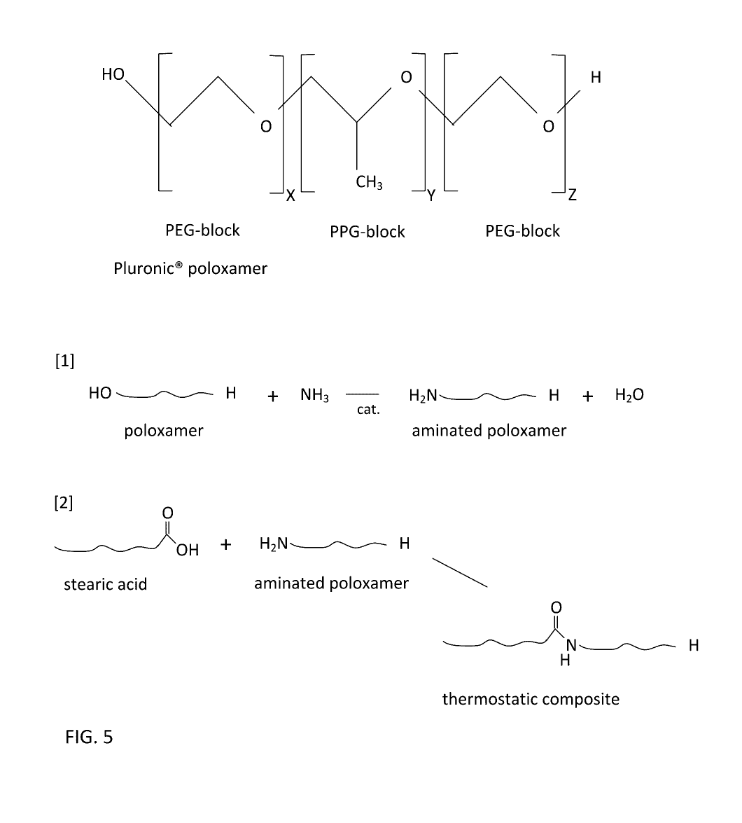

A thermostatic composite (FIG. 5) of a thermoreversible gel and a phase change material includes, respectively, about 40 wt % of the poloxamer Pluronic® F127 (Wyandotte Chemicals Corporation, Michigan, USA) (gelation temperature of about 10° C.) conjugated with about 60 wt % of the fatty acid, isopropyl stearate (melt temperature of about 14° C. to about 18° C.). The thermostatic composite is expected to have a thermal buffering capacity at temperatures of about 14° C. to about 18° C. Other fatty acid alternatives and their respective melting temperatures may include propyl palmitate—10° C., isopropryl palmitate—1° C., caprylic acid—16° C., butyl stearate—19° C., and dimethyl sabacate—21° C.

### Example 2

### Production of a Poloxamer-Stearate Thermostatic Composite

The thermostatic composite of Example 1 is conjugated by reacting amino-terminated Pluronic® F127 (Wyandotte Chemicals Corporation, Michigan, USA) with the carbonyl of the fatty acid to form amide bonds.

As generally represented in FIG. 5, the terminal alcohol groups (—OH) of the poloxamer are catalytically aminated to functionalize the poloxamer for conjugation.

The poloxamer-NH₂ (1 g, 0.079 mmol), stearic acid (90 mg, 0.316 mmol) and EDC (EDC=1-ethyl-3-(3-dimethylaminopropyl) carbodiimide hydrochloride) (210 mg, 2.92 mmol) are dissolved in 10 mL DMSO. The mixture is stirred in a nitrogen atmosphere at room temperature for about 50 hours. The solution is transferred into a dialysis bag and dialyzed against doubled distilled water for 5 days to remove unreacted EDC. The final product composite is freeze-dried.

### Example 3

### Thermostatic Food Packaging and Method of Insulating a Food Item to Keep the Food Item Cool

The thermostatic composite of Example 1 is usable as a dry powder for thermally insulating food items that are stored or transported in a warm ambient environment. The food items may be cheeses, chocolates or any food item that can spoil or deform under heat, for example above 20° C. A layer of the composite is placed along the bottom of a box container. The food items and the composite material are alternately layered within the box container, with the top layer being the composite material. Accordingly, the food packets are surrounded with the composite material within the box container. During transporting or storage, as the ambient temperature rises to at or above a melt temperature of the phase change material, the material will absorb heat from the ambient surroundings as the phase change material melts, thereby providing insulation to the food items. The liquefied phase change material will be retained within the gel or semi-solid form of the poloxamer conjugated with the phase change material, thereby avoiding any loss of the phase change material and contamination of the food items by the phase change material. The thermostatic composite is expected to maintain the food items at about 14° C. to about 18° C. under varying temperature escalations of the surrounding environment.

### Example 4

### A Poloxamer-Fatty Acid Thermostatic Composite for Retaining Heat

A thermostatic composite (FIG. 5) of a thermoreversible gel and a phase change material includes, respectively, a poloxamer-NH₂ with a transition temperature of about 37° C. conjugated a fatty acid having a melting temperature of about 50° C. to about 60° C., such as palmitic acid (melting temperature of about 61° C. to about 64° C.) or myristic acid (melting temperature of about 49° C. to about 58° C.). The thermostatic composite is expected to have a thermal buffering capacity at temperatures of about 50° C. to about 60° C.

### Example 5

### Thermostatic Food Packaging and Method of Insulating a Food Item to Keep the Food Item Warm

The thermostatic composite of Example 4 is usable as an insulating bag for thermally insulating warm food items that are transported in a cooler ambient environment. The food items may be a delivery pizza, for example, or any food item that should be kept warm or hot, for example above 50° C. A thermal bag may be constructed of the composite material so that a pizza box container may fit within the bag. Once a pizza is baked and ready for delivery, the pizza may be placed within the delivery box, that may then subsequently be placed within the insulating bag to keep the pizza hot during delivery. During transporting, since the ambient temperature is less than a melt temperature of the phase change material, the phase change material will emit heat as the phase change material cools and solidifies, thereby providing heat to the food item to keep the food item from cooling. The thermostatic composite is expected to maintain the food item at about 50° C. to about 60° C. in a cooler surrounding environment.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A thermostatic material comprising:
at least one phase change material having a melt temperature, wherein at a temperature above the melt temperature the at least one phase change material is a liquid phase change material, and at a temperature below the melt temperature the at least one phase change material is a solid phase change material; and
at least one thermoreversible gel having a gelation temperature, wherein at a temperature above the gelation temperature the at least one thermoreversible gel is a gelled thermoreversible gel, and at a temperature below the gelation temperature the at least one thermoreversible gel is a liquid thermoreversible gel,
wherein the gelation temperature is less than or equal to the melt temperature.

2. The thermostatic material of claim 1, wherein:
at least one of the at least one phase change material and the at least one thermoreversible gel is a solid or semi-solid at a temperature less than the melt temperature; and
at least one other of the at least one phase change material and the at least one thermoreversible gel is a solid or semi-solid at a temperature above the gelation temperature.

3. (canceled)

4. The thermostatic material of claim 1, wherein the at least one phase change material and the at least one thermoreversible gel are configured to maintain the thermostatic material in a flowable state over a range of temperatures from a first temperature less than the gelation temperature to a second temperature greater than the melt temperature.

5. The thermostatic material of claim 1, wherein the liquid thermoreversible gel is a colloidal solution and the gelation temperature is a sol-gel transition temperature.

6. The thermostatic material of claim 1, wherein the gelation temperature and melt temperature are about −10° C. to about 80° C.

7. The thermostatic material of claim 1, wherein the at least one thermoreversible gel comprises poly(ethylene glycol), poly(ethylene glycol) grafted chitosan, a poloxamer, poly(ethylene glycol)-poly(lactic-co-glycolic acid)-poly(ethylene glycol) triblock copolymer, or combinations thereof.

8. The thermostatic material of claim 1, wherein the at least one thermoreversible gel is poly(ethylene glycol)-grafted chitosan comprising poly(ethylene glycol) in an amount of about 45 wt % to about 55 wt %.

9. The thermostatic material of claim 1, wherein the at least one phase change material comprises polycaprolactone, paraffin, paraffin constituents, fatty acids, fatty acid esters, palmitates, stearates, vegetable oils, waxes or combinations thereof.

10. The thermostatic material of claim 1, wherein the at least one phase change material comprises paraffin (CₙH₂ₙ₋₂) functionalized with maleic anhydride, where n is greater than or equal to about 16, and n is less than or equal to about 50.

11.-13. (canceled)

14. The thermostatic material of claim 1, wherein the phase change material is stearic acid, the thermoreversible gel is a poloxamer and the thermostatic material is a poloxamer-stearate copolymer.

15.-16. (canceled)

17. A food packaging comprising:
at least one phase change material having a solid state at a first temperature and a liquid state at a second higher temperature; and
at least one thermoreversible gel having a liquid state at the first temperature and a gel state at the second temperature,
wherein at least one of the at least one phase change material and the at least one thermoreversible gel is a solid or semi-solid at a temperature in a range of temperatures from a third temperature less than the first temperature to a fourth temperature greater than the second temperature.

18. The food packaging of claim 17, wherein the at least one thermoreversible gel comprises poly(ethylene glycol), poly(ethylene glycol) grafted chitosan, a poloxamer, poly(ethylene glycol)-poly(lactic-co-glycolic acid)-poly(ethylene glycol) triblock copolymer, or combinations thereof.

19. The food packaging of claim 17, wherein the at least one thermoreversible gel is poly(ethylene glycol)-grafted chitosan comprising poly(ethylene glycol) in an amount of about 45 wt % to about 55 wt %.

20. The food packaging of claim 17, wherein the at least one phase change material comprises polycaprolactone, paraffin, paraffin constituents, fatty acids, fatty acid esters, palmitates, stearates, vegetable oils, waxes or combinations thereof.

21. The food packaging of claim 17, wherein the at least one phase change material comprises paraffin functionalized with maleic anhydride.

22.-24. (canceled)

25. The food packaging of claim 17, wherein the at least one phase change material is stearic acid, the at least one thermoreversible gel is a poloxamer and the thermostatic material is a poloxamer-stearate copolymer.

26.-34. (canceled)

35. A method for producing a thermostatic material, the method comprising:
combining at least one phase change material with at least one thermoreversible gel, wherein the phase change material has a melt temperature at which the phase change material changes from a solid to a liquid, the thermoreversible gel has a gelation temperature at which the thermoreversible gel changes from a liquid to a gel, and the gelation temperature is less than or equal to the melt temperature.

36. The method of claim 35, wherein combining comprises combining with at least one thermoreversible gel including poly(ethylene glycol), poly(ethylene glycol) grafted chitosan, a poloxamer, poly(ethylene glycol)-poly(lactic-co-glycolic acid)-poly(ethylene glycol) triblock copolymer, or combinations thereof.

37. The method of claim 35, wherein combining comprises combining with at least one thermoreversible gel including poly(ethylene glycol)-grafted chitosan comprising poly(ethylene glycol) in an amount of about 45 wt % to about 55 wt %.

38. The method of claim 35, wherein combining comprises combining at least one phase change material including polycaprolactone, paraffin, paraffin constituents, fatty acids, fatty acid esters, palmitates, stearates, vegetable oils, waxes or combinations thereof.

39. The method of claim 35, wherein the combining step comprises:
liquefying the phase change material; and
covalently bonding the phase change material with the thermoreversible gel.

40. The method of claim 35, wherein combining comprises:
amino terminating a poloxamer to provide free amino groups on the poloxamer;
liquefying stearic acid having free carboxyl groups; and
conjugating the amino groups of the poloxamer and the carboxyl groups of the stearic acid to form the thermostatic material comprising a poloxamer-stearate copolymer.

41. The method of claim 35, wherein:
combining comprises:
liquefying the at least one phase change material;
providing the at least one thermoreversible gel having pores; and
infiltrating the at least one phase change material into pores of the at least one thermoreversible gel.
